(19) United States
(12) Patent Application Publication
(10) Pub. No.: US 2008/0297304 A1
(43) Pub. Date: Dec. 4, 2008

(54) System and Method for Recording a Person in a Region of Interest

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 12/131,661

(22) Filed: Jun. 2, 2008

Related U.S. Application Data
(60) Provisional application No. 60/941,446, filed on Jun. 1, 2007.

(51) Int. Cl. G05B 23/02; H04N 7/18

(52) U.S. Cl. 340/3.1; 348/159; 348/E07.085

(57) ABSTRACT

A method and system for recording a player in at least one zone of a playing Field are described herein. The system includes at least one set of cameras, each set containing one or more cameras. Each zone is associated with one set of cameras which is used to obtain a set of video data from the zone associated therewith. The player wears an emitter of electromagnetic signals. A sensor apparatus receives and processes the electromagnetic signals to obtain location information indicative of when the player is located in a particular zone. A video processing module, in data communication with the at least one set of cameras, utilizes the location information to extract video information of the player from the at least one set of video data.

### CROSS-REFERENCE TO RELATED APPLICATION

This application claims priority to U.S. Patent Application No. 60/941,446, filed Jun. 1, 2007.

### BACKGROUND OF THE INVENTION

There are several reasons that players or athletes videotape their performances on the playing field. One reason is instructional. By watching a video of a sporting activity, the athlete participating therein can more easily identify flaws in his technique that he can then attempt to correct. Another reason for videotaping a player has more to do with entertainment. For the same reasons that people take photographs, players may want to videotape themselves in action for enjoyment at a later date.

Currently, a typical way in which a player is videotaped is to have an acquaintance or relative bring a video camera to a game in which the player is participating to videotape the player in action. A disadvantage in this approach is that a player needs to arrange to have someone come to the game who is willing to perform the task of videotaping. Moreover, a camera must be brought to the game, which may be a nuisance. The vantage point from which the person is allowed to videotape the game may also be unfavorable.

Thus, an invention that would offer an alternative to this approach for recording players in action would be welcome.

### SUMMARY OF THE INVENTION

Described herein is a method and system for recording a person, such as a player or athlete, in at least one zone of a region of interest, such as a playing field. The system includes at least one set of cameras, each set having one or more cameras. Each one of the zones of the playing field is associated with a set of cameras, which set is used to obtain a set of video data from the zone associated therewith. The system further includes an emitter worn by the player for emitting electromagnetic signals. A sensor apparatus receives and processes the electromagnetic signals to obtain location information indicative of when the player is located in a particular zone. The system also includes a video processing module in data communication with the at least one set of cameras for using the location information to extract video information of the player from the at least one set of video data.

### BRIEF DESCRIPTION OF THE DRAWINGS

FIG. 1 is a block diagram of a system for recording a person in one or more zones of a region of interest, according to the principles of the present invention;

FIG. 2 shows a plan schematic of a playing field and sets of cameras for recording play thereon, according to the principles of the present invention;

FIG. 3 is a block diagram of a video delivery apparatus, according to the principles of the present invention;

FIG. 4 is a perspective view of the video delivery apparatus of FIG. 3;

FIG. 5 is a block diagram of another embodiment of a video delivery apparatus, according to the principles of the present invention; and

FIG. 6 is a block diagram of another embodiment of a system for recording a player in one or more zones of a playing field, according to the principles of the present invention.

### DESCRIPTION OF THE INVENTION

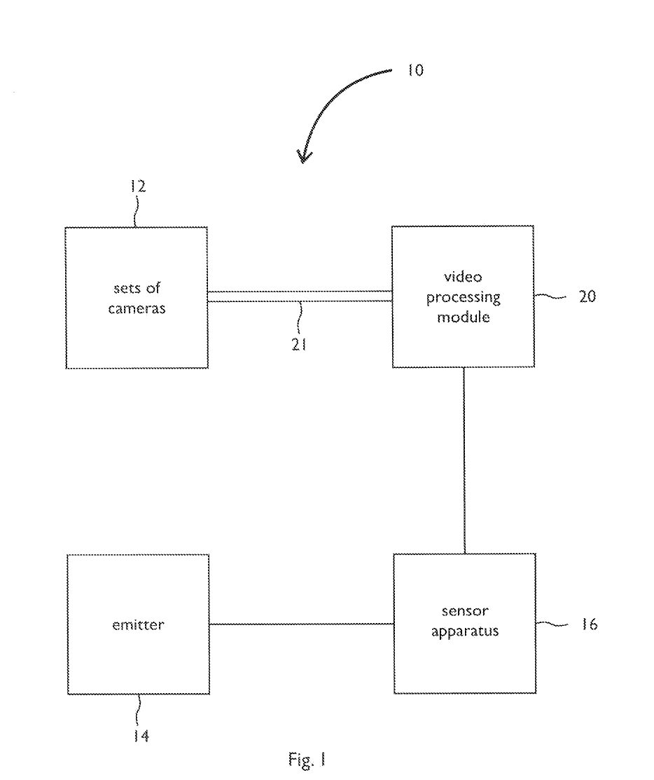

FIG. 1 shows a block diagram of a system 10 for recording a player in one or more zones of a playing field. The system 10 includes at least one set of cameras 12, where each set contains at least one camera, and each zone is associated with a set of cameras. Each set of cameras obtains a set of video data from the zone associated with the set.

The system 10 also includes an emitter 14 worn by the player for emitting electromagnetic signals, and a sensor apparatus 16 for receiving the signals. The sensor apparatus 16 also processes the signals to obtain location information indicative of when the player is located in a particular zone. The sensor apparatus can include an array of receiver modules located at various locations in or about the playing field to obtain the location information.

The system 10 further includes a video processing module 20 that is in data communication with the at least one set of cameras 12 using any appropriate data communication link 21 known to those of ordinary skill, such as by an Ethernet link, or by a wireless link. The video processing module 20 includes software and/or hardware for using the location information to extract video information of the player from the at least one set of video data. The video information of the player is video information that can be processed to show video footage of the player.

In one embodiment, the video processing module 20 can use the location information to zoom in on the player to thus provide a close-up of the player in action. In other words, the location information can indicate where within a particular zone the emitter, and hence the player is located. The video processing module 20 can then crop out data corresponding to an area where the emitter is not located, and zoom in on an area where the emitter is located.

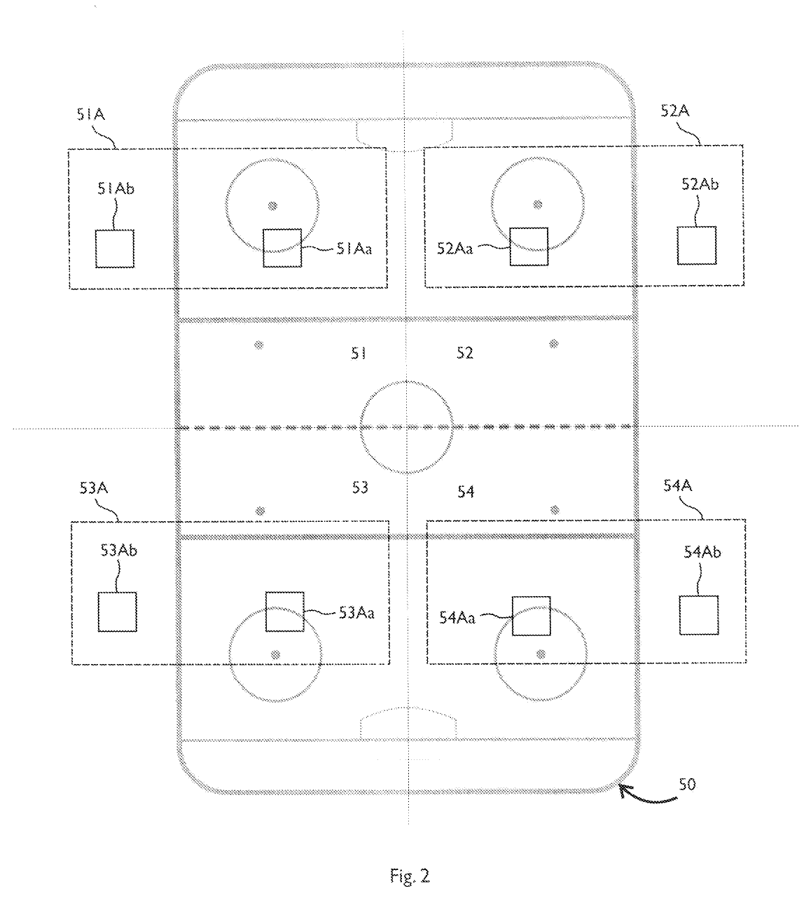

FIG. 2 shows a schematic of a playing field and sets of cameras, similar to the at least one set 12 described in relation to FIG. 1, for recording play thereon. The playing field 50, a hockey rink in the example shown, is divided into four zones 51-54. In general, the number of zones could be different from four. The zones could be contiguous or non-contiguous, overlapping or non-overlapping, and/or exhaustive (i.e., spans the whole playing field) or non-exhaustive. In addition, in some embodiments it is also possible that two (or more) zones are associated with one set of cameras.

Referring back to the example of FIG. 2, each of the zones 51, 52, 53 and 54 is respectively associated with a set of cameras 51A, 52A, 53A and 54A. The set of cameras 51A has two cameras 51Aa and 51Ab. The set of cameras 51A obtains a set 51B of video data from the zone 51. In particular, camera 51Aa obtains video data 51Ba from the zone 51, and camera 51Ab obtains video data 51Bb from the zone 51. Thus, the set 51B of video data includes video data 51Ba and video data 51Bb.

Likewise, the set of cameras 52A obtains a set 52B of video data from the zone 52, and similarly for the other sets. In general, the number of cameras in each set of cameras can vary so that the sets of cameras need not have the same number of cameras.

The cameras 51Aa and 51Ab record play in zone 51 from two different vantage points or perspectives. In the example shown, camera 51Aa records play from an overhead perspective, and camera 51Ab records play from a side perspective. Likewise, the cameras 52Aa, 53Aa and 54Aa record action from overhead perspectives, while cameras 52Ab, 53Ab and 54Ab record action from side perspectives from their respective zones.

During a game, the player enters and leaves a particular zone during play, and may leave the ice surface all-together, to sit on his team's bench or in the penalty box, for instance. (In some embodiments, however, the penalty box might be included as part of the playing field, and designated as part of another zone or a separate zone, if footage from the penalty box is desired.) Thus, the sets of video data 51B, 52B, 53B and 54B do not all contain information relevant to the player at the same time. For example, if at time t the player is in zone 51, and if the zones are not overlapping, then the sets of video data 52B, 53B and 54B are “irrelevant” for the player at that time in the sense that these sets of video data do not capture the player at this time. As described below, the emitter 14 and the sensor apparatus 16 are used to obtain location information of the player that can in turn be used by the video processing module 20 to extract video information of the player from the at least one set of video data. Such video information can be further processed to show video footage of the athlete.

One example of an emitter 14 that is commercially available and that can be used in the system 10 is the Ubisense Tag™, available from Ubisense, Inc. of Cambridge, United Kingdom. In this example, the sensor apparatus 16 can include one or more Ubisensor Sensors™, also available from Ubisense, Inc., for receiving electromagnetic signals from the emitter 14, and for processing the electromagnetic signals to obtain location information indicative of when the athlete is located in a particular zone. The sensor apparatus 16 includes any hardware and software for receiving and processing the electromagnetic signals to obtain the location information.

The player wears the tag or emitter 14 that emits ultra-wideband electromagnetic signals. The sensor apparatus 16, which can include a plurality of Ubisensor sensors disposed in different locations near the playing field, receives the signals for processing. This emitter 14 and sensor apparatus 16 can be used to obtain the location of the player down to about 6 inch three-dimensional accuracy.

The video processing module 20 receives the at least one set of video data captured by the at least one set of video cameras 12, and the location information obtained using the sensor apparatus 16. From the location information, the video processing module 20 can determine where—in particular in which zone—the player is located, and at what time. From this information, the video processing module 20 can choose those portions of the sets of video data that includes video information of the player. For example, the video processing module 20 may determine that between the times t1 and t2, the player is in zone 51, during the time t2 and t3 the player is in zone 54, and during the time t4 and t5 the player is back in the zone 51, where, in this example, it is assumed that t1<t2<t3<t4<t5. Between time t3 and t4, the player may not be in any zone, as would occur if the player left the playing field for whatever reason.

The video processing module 20 can store the video information that is relevant to the player. As described below, a video delivery system can then be used to transfer the video information to a suitable medium that can later be used to play back the action of the player on a display screen. For example, the relevant portions of the sets of video data can be burned onto a DVD or flash memory devices in time-sequential order, or in some other order.

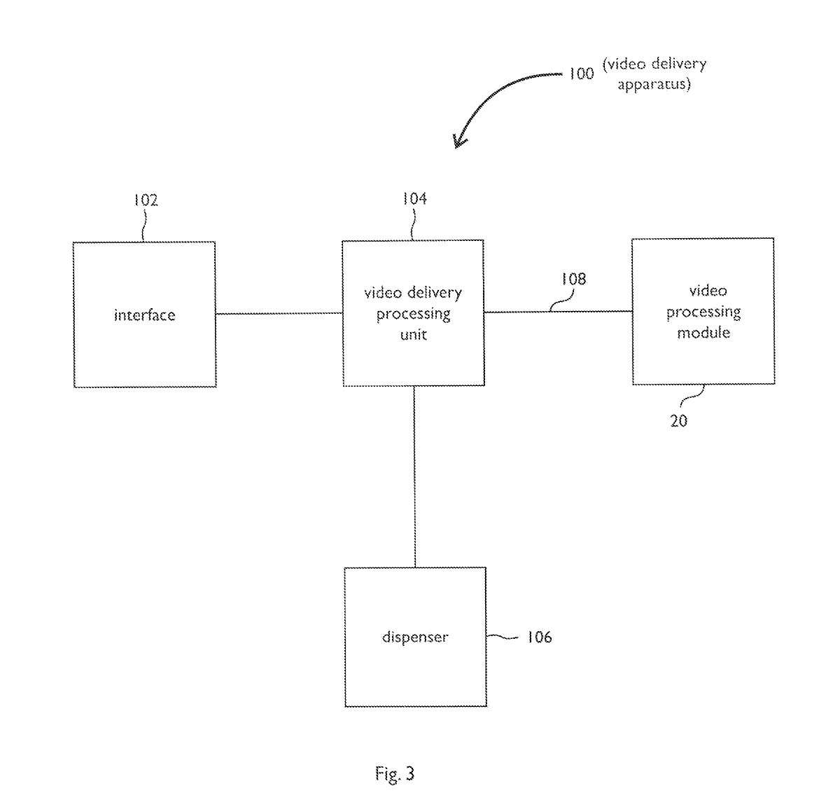

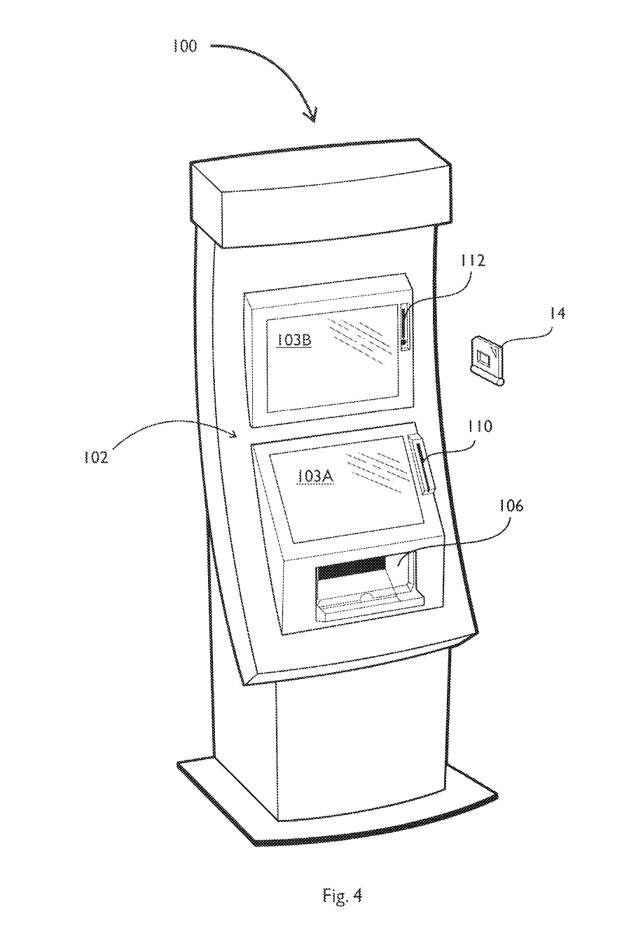

In one aspect of the present invention, an opportunity is presented to a user to acquire video information, in some appropriate medium, Such as a DVD or flash memory device, associated with action of the player, perhaps the user, during a game. Thus, in one embodiment of the present invention, and with reference to FIGS. 3 and 4, a video delivery apparatus 100 is provided containing an interface 1 02, which can include screens 103A and 103B, a video delivery processing unit 104, a dispenser 106 and a link 108 to the video processing module 20.

The interface 102 allows the user to interact with the apparatus 100. For example, one of the screens 103A can be a touch screen for entering data by touching the screen. Another screen 103B can be used to provide information to the user, including a sample of video that the user can purchase.

The video delivery processing unit includes software and/or hardware for a) receiving instructions from the user via the interface, b) cooperates with the video processing module to extract the appropriate video information based on the instructions and c) causes the dispenser to provide video information to the user in an appropriate medium.

In some embodiments, some or all of the hardware of the video processing module 20 and the video delivery processing unit 104 can coincide. For example, the video processing module 20 and the video delivery processing unit can share components, such as memory devices or microprocessors. For instance, one computer can serve to both a) extract video information of the player from the at least one set of video data, and b) receive instructions from the user via the interface and cause the dispenser to provide video information to the user in an appropriate medium In one embodiment, the user can utilize the interface 102 to enter an identification number associated with the particular emitter 14. That information, and optionally other information that the user provides, is input into the video delivery processing unit 104, which downloads, via the link 108, all or part of the video information associated with the player that wore the particular emitter 14 during a game. In other words, the video information includes portions of the sets of video data associated with the player.

The user of the apparatus 100 can use the interface 102, which can include one or more display screens, to enter one or more options. For example, the user can choose the medium on which the video information is to be stored, such as a DVD. In addition or instead, the user can choose to have the data emailed to a particular email addressed entered by the user. The user can also choose a method of payment, such as by credit card that can be swiped using a card reader 110.

The user can also use the interface 102 to enter information regarding the formatting of the video information. In a simple example, the user may choose, or it may be the apparatus' default, to dump all of the raw video information relevant to the player (in other words, information that can be used to show footage of the player in action) onto a DVD for later processing and/or viewing. In the example above, this might result in a DVD that shows for the first time interval t2−t1 video footage associated with a subset of the set 51Ba (overhead perspective), for the next time interval t2−t1 video footage associated with a subset of the set 51Bb (side perspective of the same action), for the next time interval t3-t2 video footage associated with a subset of the set 54Ba (overhead perspective), for the next time interval t3−t2 video footage associated with a subset of the set 54Bb (side perspective of the same action), for the next time interval t5−t4 video footage associated with another subset of the set 51Ba (overhead perspective) and for the next time interval t5-t4 video footage associated with another subset of the set 51 Bb (side perspective of the same action). Video footage associated with these subsets might be shown spliced together with no gaps, so that the total length of the DVD would be 2(t2−t1)+2(t3−t2)+2(t5−t4). At all times during the viewing of this DVD, the particular player associated with the emitter 14 would be present.

Many other options could be presented to the user via the interface 102. For example, the user might choose only one perspective, such as an overhead perspective for example, or only certain time intervals, such as only the last ten minutes of the game. Different price structures might be in effect: the longer the video selected, the more expensive the DVD, for example.

As mentioned above, the zones of the playing field can be overlapping. For example, with reference to FIG. 1, in addition to the four zones shown, a fifth zone, which is associated with a fifth set of cameras, can correspond to the whole rink. During the times in which the player is not on the ice, the player may choose to have footage of the fifth zone (i.e., the whole rink) shown. In the previous example, instead of leaving a gap between times t3 and t4, the player might choose to show video footage of video data obtained by the fifth set of cameras, and in particular just from one camera from the fifth set that captures video data from an overhead perspective, for example. Thus, after the time period from t2 to t3, footage of an overhead perspective of the whole rink that excludes the player can be shown for the period from t3 to t4. The next sequence for the time period t4 to t5 would once again show the player in action. It will be appreciated that the options of video sequences are limitless, although in one embodiment, the video delivery apparatus 100 might present just a handful of options.

Data on the DVD or other device could be stored in such a way as to display several viewing angles simultaneously, which might be particularly desirable for viewing on a multi-screen display system. For example, on a two-screen display system, one screen can show a side view of the action, while the second screen shows an overhead view of the action.

If all of the player's relevant data is stored on the DVD, the data can later be edited, at the user's leisure, using commercially available video editing software, known to those of ordinary skill.

In games involving more than one player, each player can use the apparatus 100 and the principles of the present invention described above to obtain a personalized DVD of the player's actions on the playing field. With two emitters, for example, two players can obtain individualized video footage. Thus, the interface 102 can be used to input an identifier that identifies the user to the apparatus 100 to allow the apparatus 100 to produce a DVD containing video data relevant to the particular user.

The video delivery apparatus 100 can include an emitter receptor 112 for accepting an emitter 14. In one embodiment, the player has to return the emitter 14 by inserting it into the emitter receptor 112 before being able to obtain video information from the video delivery apparatus 100. The purpose of inserting the emitter 14 into the emitter receptor 112 could include allowing the apparatus 100 to identify the player, and also to encourage the player to return the emitter 14. For the former purpose, a receiver could be included in the apparatus 100 to identify the emitter from signals emitted by the emitter.

In addition, the player may be required to first obtain the emitter before a game from the video delivery apparatus. In one embodiment, the player would swipe a credit/debit card into the card reader 110 to provide a deposit for the emitter, which is then refunded once the emitter 14 is returned by inserting the emitter 14 into the emitter receptor 112 after the game.

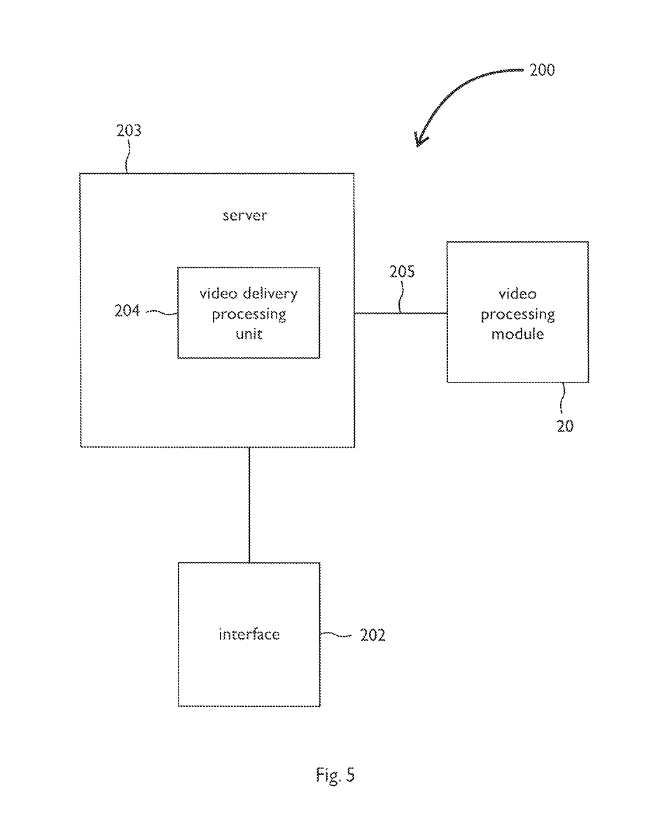

In a different embodiment, the video delivery apparatus can instead or in addition to that shown in FIGS. 3 and 4 be Web-based. In particular, and with reference to FIG. 5, a block diagram of a different embodiment of a video delivery apparatus 200 is shown. The video delivery apparatus 200 comprises a server 203, which includes a video delivery processing unit 204, connected to the Internet. Video information from the video processing module 20, which is generated using the sets of video data from the sets of cameras 12, is sent via an Internet link 205 to the video delivery processing unit 204. An interface 202, such as a personal computer or laptop, allows a user to interact with the server 203 via the Internet. The user can log onto a website that allows the user to obtain video information that can be used to show video of the player in action. On the website, options are available that would allow the user to choose what type of video information he desires. As discussed above, the user can choose to obtain video information from various perspectives and relevant to him, in other words, that shows portions of the game in which he is participating. Advantageously, this embodiment allows the user/player to make a purchase in the convenience of his home well after the game.

In addition to having one or more sets of cameras, one or more microphones can capture sound of the action on the ice, which can be added to the DVD or other storage device, for example, to add audio to the video footage.

In one embodiment, the set of cameras to which a particular zone is associated will record video data only when at least one emitter is in the zone, and likewise for the other sets of cameras. In this manner, if there are no players in a particular zone, no video data from that zone is captured until at least one emitter enters the zone, at which point the particular set of cameras are activated for recording.

In yet another embodiment, each emitter is associated with a subset of each of the at least one set of cameras 12. Each such subset can pan, tilt, zoom, rotate or translate to track and more closely follow the player wearing the emitter when the player is in a particular zone associated with the set of cameras. For example, assuming for simplicity that a maximum of two emitters are available, and referring to the configuration of FIG. 2, camera 51Aa could pan tilt, and/or zoom in the direction of the first emitter when the first emitter is in zone 51, and camera 51Ab could pan, tilt and/or zoom in the direction of the second emitter when the second emitter is in zone 51. In such manner, close-up overhead footage of the player wearing the first emitter and close-up side footage of another player wearing the second emitter could be obtained. If instead of two cameras in the set 51A, two more cameras were included, for a total of four, denoted by overhead camera 51Aa1, overhead camera 51Aa2, side camera 51Ab1 and side camera 51Ab2, then cameras 51Aa1 and 51Ab1 could take close-up footage of the first player from overhead and side, and likewise for the second player using cameras 51Aa2 and 51Ab2. Similar considerations could apply to the other zones 52-54. It should be understood that with an increase in the available cameras, more emitters (and therefore players) could be tracked from various perspectives.

In operation, a player obtains an emitter, which can be bought, rented, or loaned, for example. After the player activates the emitter, by turning it on, the player wears the emitter during part or all of a game. Turning on the emitter may also send a signal that activates the rest of the system 10, turning the at least one set of cameras 12 on, for example. Alternatively, someone has to turn the rest of the system on, either before the player obtains the emitter or after. The system 10 records parts or all of his play during the game.

After the game, a user, who is typically the player, but could be another person, approaches the video delivery apparatus 100. The user provides an identifier to the interface 102 that is associated with a particular emitter worn by a particular player. Optionally, as a condition for continuing to operate the apparatus to completion (i.e., until video data is purchased), the user may have to return the emitter by inserting the emitter into an emitter receptor 108 of the apparatus 100, which recognizes the emitter and allows the player to proceed with the purchase of video data. For example, the user may purchase a DVD containing video data to show footage of the player during play.

In another Web-based embodiment described above, the user/player uses a home computer, for instance, to log on to a website for the purchase of video footage of the player during the game.

Although reference has been made to recording a player in a playing field, the principles of the invention can be applied to the recording of a person, such as an actor, in at least one zone of a region of interest, such as a stage.

It should also be understood that the number of zones can vary from as little as one to more. In one embodiment, for instance, there can be exactly one zone coinciding with the entire region of interest. One set of cameras, containing one or more cameras, could then track the player in the one zone.

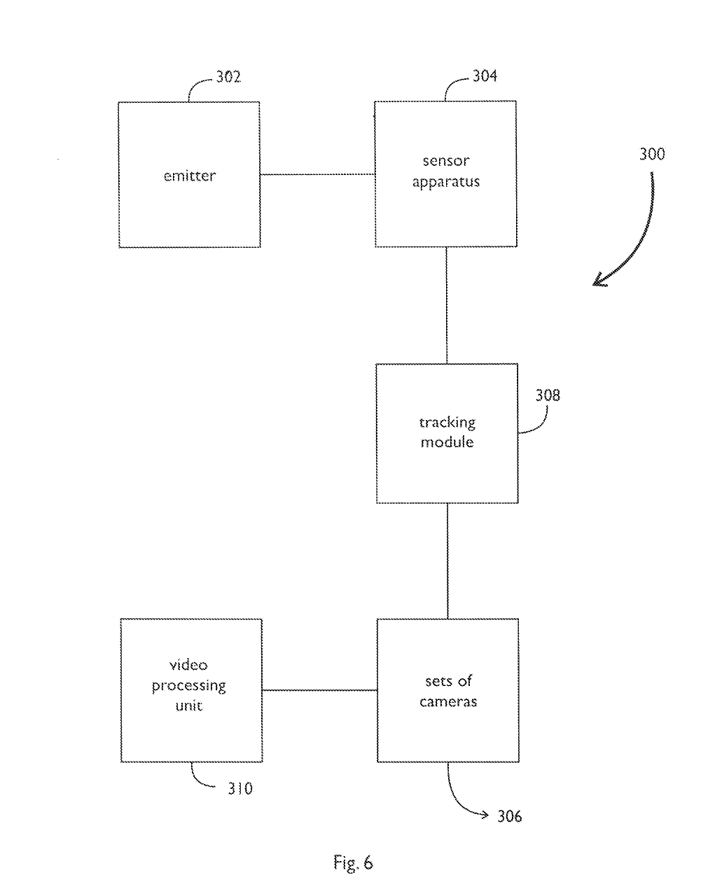

With reference to FIG. 6, a block diagram of a system 300 for recording a person in at least one zone of a region is shown. The system 300 includes an emitter 302 worn by the person for emitting electromagnetic signals. The system 300 also includes a sensor apparatus 304 for receiving and processing the electromagnetic signals to obtain location information indicative of where and/or when the person is located in a particular zone. Examples of a commercially available emitter and sensor apparatus are disclosed above. The system 300 further includes at least one set of cameras 306 capable of panning, tilting, translating and/or zooming. Each set contains at least one camera, and each zone is associated with one of the at least one set of cameras.

The system also includes a tracking module 308. The tracking module 308 includes software and/or hardware that processes the location information to send tracking signals to the at least one set of cameras so that when the player is in a zone, the set of cameras associated therewith tracks the player to obtain a set of video data. For example, the cameras can pan, tilt, translate and/or zoom towards the player. Thus, with each zone, an associated set of video data is obtained.

The system 300 further includes a video processing module 310 for extracting video information of the player from each of the sets of video data. The video processing module obtains video information of the player from one or more sets of video data. A representation of the video information is suitable for storage in a memory device that can be used to show video footage of the person in at least one zone of the region of interest. A video delivery apparatus, such as the video delivery apparatus 100 described above, provides video information stored in an appropriate medium, such as a DVD or flash memory device, to a user and/or player.

As before, the zones could be contiguous or non-contiguous, overlapping or non-overlapping, and/or exhaustive (i.e., spans the whole playing field) or non-exhaustive. In addition, it is also possible that two (or more) zones are associated with one set of cameras.

While embodiments of this invention have been illustrated in the accompanying drawings and described above, it will be evident to those skilled in the art that changes and modifications may be made therein without departing from the essence of this invention. The scope of the invention is defined by the following claims.

What is claimed is:

1. A system for recording a person in at least one zone of a region of interest, the system comprising:
at least one set of cameras, wherein a) each set contains at least one camera, b) each zone is associated with one of the at least one set of cameras and c) each set of cameras obtains a set of video data from the zone associated with the set of cameras;
an emitter worn by the person for emitting electromagnetic signals;
a sensor apparatus for receiving and processing the electromagnetic signals to obtain location information indicative of when the person is located in a particular zone; and
a video processing module in data communication with the at least one set of cameras for using the location information to extract video information of the person from the at least one set of video data.

2. The system of claim 1, further comprising a video delivery apparatus cooperating with the video processing module for delivering to a user data corresponding to at least a portion of the video information of the person.

3. The system of claim 1, wherein each set of cameras contains at least one camera capable of obtaining video data from an overhead perspective.

4. The system of claim 1, wherein each set of cameras includes at least two cameras, one of which is capable of obtaining video data from a side perspective.

5. The system of claim 1, wherein the at least one zone includes two or more zones.

6. The system of claim 5, wherein the two or more zones are overlapping.

7. The system of claim 1, wherein a subset of one of the at least one set of cameras tracks the emitter.

8. The system of claim 1, wherein each set of cameras records only when the emitter is disposed in the zone associated with the set.

9. The system of claim 2, wherein the video delivery apparatus includes an interface to allow the user and the video delivery apparatus to communicate.

10. The system of claim 9, wherein the interface includes at least one screen.

11. The system of claim 10, wherein the video delivery apparatus further includes a card reader for the user to swipe a credit or debit card.

12. The system of claim 1, wherein at least one of the at least one set of cameras includes a subset that tracks the emitter.

13. A method for recording a person in at least one zone of a region of interest, the method comprising:
providing at least one set of cameras, wherein each set contains at least one camera and each zone is associated with one of the at least one set of cameras;
with each set of cameras, obtaining a set of video data from the zone associated with the set of cameras;
emitting electromagnetic signals with an emitter worn by the person;
receiving and processing the electromagnetic signals to obtain location information indicative of when the person is located in a particular zone; and
using the location information to extract video information of the person from the at least one set of video data.

14. The method of claim 13, further comprising delivering to a user data corresponding to at least a portion of the video information of the person.

15. A system for recording a person in at least one zone of a region of interest, the system comprising:
an emitter worn by the person for emitting electromagnetic signals;
a sensor apparatus for receiving and processing the electromagnetic signals to obtain location information indicative of where the person is located in a particular zone;
at least one set of cameras, wherein each set contains at least one camera, and each zone is associated with one of the at least one set of cameras;
a tracking module for using the location information to send tracking signals to the at least one set of cameras so that when the player is in a zone, the set of cameras associated therewith tracks the player to obtain a set of video data; and
a video processing module for obtaining video information of the player from the set of video data, a representation of the video information being suitable for storage in a memory device that can be used to show video footage of the person in at least one zone of the region of interest.

16. The system of claim 15, further comprising a video delivery apparatus for delivering to a user the representation of the video information in the memory device.

17. The system of claim 16, wherein the memory device includes one of a DVD, a flash memory device and a memory storage device in a server.

18. The system of claim 16, wherein the video delivery device apparatus includes at least one screen for providing information to the user.

19. The system of claim 16, wherein the video delivery apparatus includes a card reader for reading debit card or credit card information for payment for access to the representation of the video information.

20. The system of claim 16, wherein the video delivery apparatus is configured to send the representation of the video information to an email address provided by the user.
